(19) United States
(12) Patent Application Publication
(10) Pub. No.: US 2009/0326977 A1
(43) Pub. Date: Dec. 31, 2009

(54) Systems and Methods for Providing Drug Samples to Patients

(75) Inventors: Peter Cullen, Atlanta, GA (US); Elizabeth S. Kaye, Suwanee, GA (US)

Correspondence Address: SUTHERLAND ASBILL & BRENNAN LLP, 999 PEACHTREE STREET, N.E., ATLANTA, GA, 30309, US

(73) Assignee: McKesson Financial Holding Limited, Hamilton (BM)

(21) Appl. No.: 12/165,172

(22) Filed: Jun. 30, 2008

(51) Int. Cl. G06Q 50/00

(52) U.S. Cl. 705/2

(57) ABSTRACT

Systems and methods for processing drug sample prescription transactions that determine whether a drug to be prescribed is eligible for sampling and/or whether the patient is eligible for sampling that drug. A prescription transaction for that drug is created and transmitted to a switch provider and is then routed to a pharmacy for prescription fulfillment. Once the prescription has been filled a message may be sent to the prescribing clinician. Moreover, the pharmacy may generate a prescription claim to be adjudicated by a claim processor where the claim specifies voucher and/or coupon information associated with the drug to be sampled that is taken into consideration either prior to or during claim adjudication. A database containing patient and/or drug information may be used to track a patients' receipt of drug samples as well as used for analyzing and/or reporting on the use of the drug sampling prescription based system.

### FIELD OF THE INVENTION

Aspects of the invention relate generally to prescription drug transactions, and more particularly to systems and methods for the processing of coupons and/or vouchers for prescription drug samples provided to patients by prescribing clinicians.

### BACKGROUND OF THE INVENTION

Drug sampling is a common practice in which a “free” sample of a prescription drug is provided to the patient by a physician. Traditionally, pharmaceutical drug representatives meet with physicians and hand deliver specialty packaged drug samples for physicians to dispense to the appropriate patients. Typically, the drug samples were stored at the physician's office and dispensed by the physician directly to the patient.

While many physicians enjoy providing drug samples to patients as an inexpensive way for a patient to try a new treatment option, the process of obtaining the drug samples from visits with the pharmaceutical drug representatives may be inconvenient, inefficient, and time consuming process to many physicians. The traditional dispensing of the drug samples at the physician's office also has additional drawbacks. For instance, often there is no record of the administration of the drug sample by the physician. As a result, a patient may receive a drug prescribed by another physician that conflicts with the sample medication with no source other than the patient for the physician to confirm the medication the patient may be taking. This may result in harm to the patient and potential liability to the physician. Additionally, the traditional method of dispensing drug samples by physicians leaves open a significant potential for abuse in the dispensing and/or use of the drug samples.

In addition to the drawbacks relating to the physician's dispensing of drug samples, there are several concerns by the drug manufacturers regarding the dispensing of drug samples including the expense associated with providing prescription drugs to be sampled. Drug manufacturers go to great expense to employ drug representatives to deliver drug samples as well as provide special packaging for drug samples such as shrink wrapping samples. Additionally, the limited monitoring and/or reporting of the dispersing of drug samples makes it difficult for drug manufacturers to determine the effectiveness of their sample programs and obtain feedback from patients using the sample drugs.

### BRIEF DESCRIPTION OF THE INVENTION

According to an embodiment of the invention, there is disclosed a method for processing drug sample prescription transactions that includes determining that a drug is eligible for sampling, receiving a prescription transaction for the drug that specifies that the drug is eligible for sampling, and submitting the prescription transaction for prescription fulfillment. In accordance with one aspect of the invention, the method further includes determining that the patient is eligible for sampling of the drug prior to submitting a prescription transaction for the drug. According to another aspect of the invention submitting the prescription transaction includes electronically routing the prescription transaction to a pharmacy over a network.

In accordance with yet another aspect of the invention, submitting a prescription transaction for the drug to a pharmacy includes providing a patient with voucher information to be presented at the pharmacy. According to another aspect of the invention, the method further includes providing a message to a clinician's office after the prescription transaction has been fulfilled. In accordance with yet another aspect of the invention, the prescription transaction for the drug includes voucher information associated with the drug. According to another aspect of the invention, the prescription transaction for the drug includes coupon information associated with the drug. In accordance with yet another aspect of the invention the method further includes amending the prescription transaction to include voucher information associated with the drug prior to submitting the prescription transaction for prescription fulfillment.

In accordance with another embodiment of the invention, there is disclosed a system for processing drug sample prescription transactions that includes a memory device and a processor in communication with the memory device. The processor is configured to execute instructions to determine that a drug is eligible for sampling, receiving a prescription transaction for the drug that specifies that the drug is eligible for sampling, and submitting the prescription transaction for prescription fulfillment.

According to one aspect of the invention, the processor is further configured to execute instructions to determine that the patient is eligible for sampling of the drug prior to submitting a prescription transaction for the drug. In accordance with another aspect of the invention, the software instructions for submitting the prescription transaction include electronically routing the prescription transaction to a pharmacy over a network. According to yet another aspect of the invention, the software instructions for submitting a prescription transaction for the drug to a pharmacy include providing a patient with voucher information to be presented at the pharmacy.

In accordance with another aspect of the invention, the processor is further configured to execute instructions to provide a message to a clinician's office after the prescription transaction has been fulfilled. According to yet another aspect of the invention, the prescription transaction for the drug includes voucher information associated with the drug. In accordance with another aspect of the invention, the prescription transaction for the drug includes coupon information associated with the drug. According to yet another aspect of the invention, the processor is further configured to execute instructions to amend the prescription transaction to include voucher information associated with the drug prior to submitting the prescription transaction for prescription fulfillment.

According to yet another embodiment of the invention, there is disclosed a method for processing a claim associated with a prescription transaction for drug sampling that includes receiving a claim associated with fulfillment of a prescription transaction for a drug eligible for sampling from a pharmacy, and transmitting the claim to a claim processor. The method further includes receiving an adjudicated claim response message from the claim processor, and transmitting at least a portion of the adjudicated claim response message to the pharmacy.

In accordance with one aspect of the invention, the method further includes updating a database containing patient information with an indication that the patient has received the drug eligible for sampling. According to another aspect of the invention, transmitting the claim to a claim processor includes routing the claim based on voucher information associated with the drug eligible for sampling. In accordance with yet another aspect of the invention, the method further includes, applying a discount to the claim prior to transmitting the claim to a claim processor, where the discount is associated with coupon information that is associated with the drug eligible for sampling.

### BRIEF DESCRIPTION OF THE FIGURES

FIG. 1 shows a system for processing prescriptions containing, or submitted with, voucher and/or coupon information for prescription drug sampling in accordance with an example embodiment of the invention.

FIG. 2 shows a data flow between the entities of the prescription drug sampling processing system for electronically submitted prescription transactions in accordance with an example embodiment of the invention.

FIG. 3 shows a flowchart of the processing of prescription drug sampling transactions in accordance with an example embodiment of the invention.

FIG. 4 shows a flowchart of the claim processor system adjudicating a claim for the drug sample prescription transaction in accordance with an example embodiment of the invention.

### DETAILED DESCRIPTION OF EMBODIMENTS OF THE INVENTION

Embodiments of the invention are directed to providing patient-specific vouchers (and/or coupons for discounted copays) with a clinician-issued prescription to a local pharmacy to obtain drug samples. In one example embodiment of the invention, a confirmation that the drug samples were provided to the patient at the pharmacy may be made available to the clinician after prescription fulfillment. The voucher (or coupon) to obtain drug samples may be faxed or hand delivered to the pharmacy or an electronic prescription transaction via a web portal that would be accessible via the clinician's computer. As an electronic prescription transaction, the clinician's existing practice management software's may be utilized. For instance, an eligibility verification may be performed to determine that the patient is eligible to participate in the drug sampling program. The resulting coupon or voucher for the drug sample is either printed for the patient or electronically sent via a switch provider (e.g., switch, router, or similar entity) to the pharmacy as a prescription (or script) that the pharmacy processes. Even if an electronic prescription transmission from the clinician (e.g., physician, nurse practitioner, pharmacist, or other prescriber) to the pharmacy is not possible, a web portal may still be accessible by the clinician to view a “virtual drug closet” allowing the clinician to select sample medication, verify patient eligibility to obtain the sample medication, and print coupon and/or voucher information as part of (or, alternatively, separate from) a prescription for the patient to present to a pharmacist to obtain the sample medication.

The systems and methods described herein may provide several advantages over traditional drug sample disbursement including: allowing for drug samples to be dispensed by a pharmacy and tracked with other patient medications; reducing and/or eliminating the need to store drug samples at a clinician's office; providing alternatives for drug manufacturers to the expensive process of packaging, maintaining, and delivering drug samples to clinician's offices; reducing inefficiencies or inconveniences associated with meetings between clinician's and pharmaceutical drug representatives; improving the evaluation of potential drug interaction effects on a patient prior to dispensing a sample drug to the patient; providing drug samples to patients independent of an on-site patient visit; and/or allowing for various combinations of drug samples to be provided via multiple vouchers and/or coupons for copay reductions.

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Embodiments of the invention are described below with reference to block diagrams and flowchart illustrations of systems, methods, apparatuses and computer program products. It will be understood that each block of the block diagrams and flowchart illustrations, and combinations of blocks in the block diagrams and flowchart illustrations, respectively, can be implemented manually and/or by computer program instructions. With respect to computer program instructions, they may be loaded onto a general purpose computer, special purpose computer such as a switch, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data-processing apparatus to cause a series of operational elements or steps to be performed on the computer or other programmable apparatus to produce a computer-implemented process such that the instructions that execute on the computer or other programmable apparatus provide elements or steps for implementing one or more functions specified in the flowchart block or blocks.

Accordingly, blocks of the block diagrams and flowchart illustrations may support combinations of means for performing the specified functions, combinations of elements or steps for performing the specified functions, and program instruction means for performing the specified functions. It will also be understood that each block of the block diagrams and flowchart illustrations, and combinations of blocks in the block diagrams and flowchart illustrations, can be implemented manually or by special purpose hardware-based computer systems that perform the specified functions, elements or steps, or combinations of special purpose hardware and computer instructions.

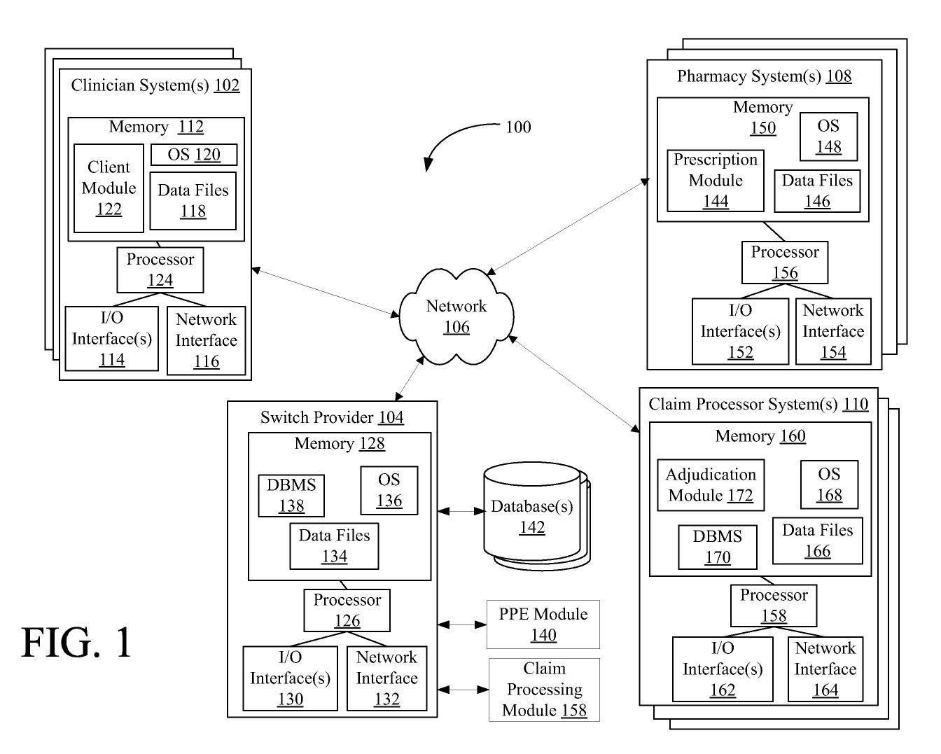

According to an example embodiment of the invention, there may be a system and method for processing voucher (or coupon) information for prescription drug samples that are to be provided to a patient by a pharmacy. FIG. 1 shows a system for processing prescriptions containing, or submitted with, voucher and/or coupon information for prescription drug sampling in accordance with an example embodiment of the invention. The overall drug sample prescription system 100 of FIG. 1 may include clinician systems 102 (e.g., physician's office practice management systems, hospital or clinic computer systems such as clinical, practice management, scheduling and/or e-prescribing systems, and the like), one or more switch providers 104, one or more pharmacy systems 108 (e.g., a pharmacy point of service device), and one or more claim processor systems 110 (e.g., insurance programs, government funded programs, benefits managers, drug manufacturers, other vendors and/or business associates of healthcare service providers, government and/or non-government entities providing financial and/or administrative services, and the like).

Each clinician system 102, switch provider 104, pharmacy system 108, and/or claim processor system 110 may be configured for accessing and reading associated computer-readable media having stored thereon data and/or computer-executable instructions for implementing the various methods in accordance with example embodiments of the invention. Generally, network devices and systems, including the one or more clinician systems 102, switch providers 104, pharmacy systems 108, and claim processor systems 110 have hardware and/or software for transmitting and receiving data and/or computer-executable instructions over a communications link and a memory for storing data and/or computer-executable instructions. These network devices and systems may also include a processor for processing data and executing computer-executable instructions, as well as other internal and peripheral components that are well known in the art. As used herein, the term “computer-readable medium” describes any form of memory or a propagated signal transmission medium. Propagated signals representing data and computer-executable instructions are transferred between network devices and systems.

The clinician system 102 may comprise any processor-driven device, such as a personal computer, laptop computer, handheld computer, and the like. The clinician system 102 may be associated with a hospital, physician's office, clinic, or another type of healthcare provider. In addition to having a processor 124, the clinician system 102 may further include a memory 112, input/output (“I/O”) interface(s) 114 and a network interface 116. The memory 112 may store data files 118 and various program modules, such as an operating system (“OS”) 120 and a client module 122. The client module 122 may include an Internet browser or other software, including a dedicated program, for interacting with the switch provider 104 via a web portal accessible through the web browser or via other communication means. For example, a user such as a physician or another prescribing entity or their agent (e.g., nurse, assistant, office clerk, etc.) may utilize the client module 122 to communicate with the switch provider 104. The client module 122 may also communicate with the pharmacy system 108, and/or the claim processor system 110.

Still referring to the clinician system 102, the I/O interface(s) 114 may facilitate communication between the processor 124 and various I/O devices, such as a keyboard, mouse, printer, microphone, speaker, monitor, bar code readers/scanners, RFID readers, and the like. The network interface 116 may take any of a number of forms, such as a network interface card, a modem, a wireless network card, and the like. These and other components of the clinician system 102 will be apparent to those of ordinary skill in the art and are therefore not discussed in more detail herein.

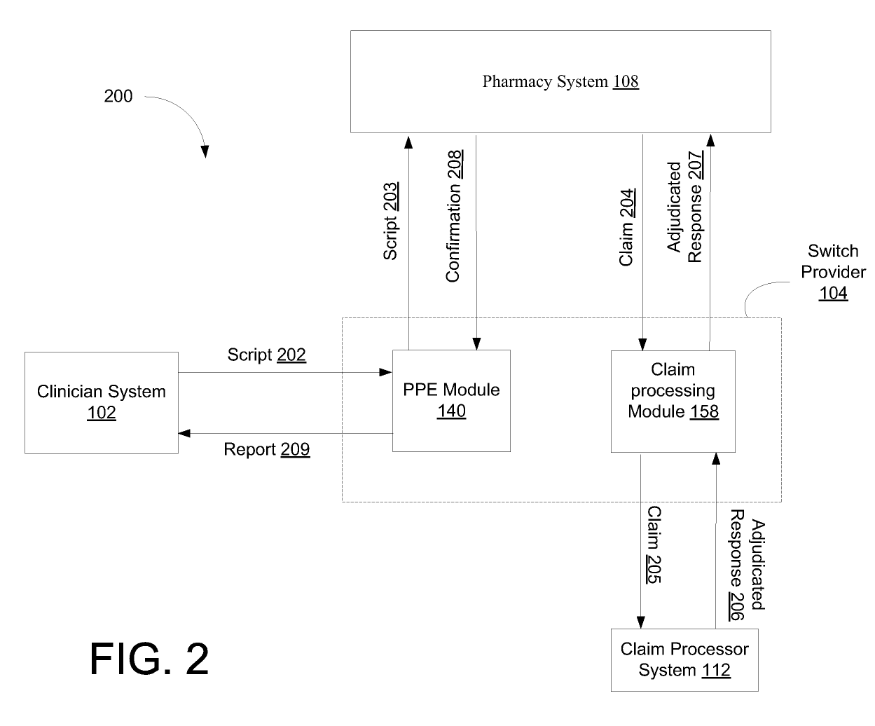

The switch provider 104 may include any processor-driven device that is configured for receiving, processing, and fulfilling prescription drug related requests and/or claims for adjudication from the clinician system 102, the pharmacy system 108, and claim processor systems 110. The switch provider 104 may include a processor 126, a memory 128, input/output (“I/O”) interface(s) 130, and a network interface 132. The memory 128 may store data files 134 and various program modules, such as an operating system (“OS”) 136 and a database management system (“DBMS”) 138. In an example embodiment of the invention, a Pre and Post Edit (PPE) module 140 provides the web portal functionality accessible by the client module 122 of the clinician system 102. In an example embodiment of the invention, the PPE module 140 receives, processes, and responds to prescription related requests from the client module 122 of the clinician system 102, and further receives, processes, and responds to requests and claims received from the prescription module 144 of the pharmacy system 108. In an example embodiment of the invention, the PPE module 140 includes a back-end analytic, editing, messaging, and reporting system for transactions between prescribing entities and pharmacies. A claim processing module 158 may receive, process, and respond to requests and claim responses received from the adjudication module 172 of one or more claim processor systems. In an example embodiment of the invention, the claim processing module 158 includes a back-end analytic, editing, messaging, and reporting system for transactions between pharmacies and claim processors. The PPE module 140 and the claim processing module 158 may be in communication with, but separate from, the switch provider 104, or alternatively, the PPE module 140 and the claim processing module 158 may be incorporated into the switch provider 104. In one example embodiment of the invention, the PPE module 140 and the claim processing module 158 may also be in communication with each other either electronically, or in an alternative embodiment, data may be provided between the two modules manually. A more detailed discussion of the functionality of the PPE module 140 and the claim processing module 158 is included below in the discussion of FIGS. 2-4.

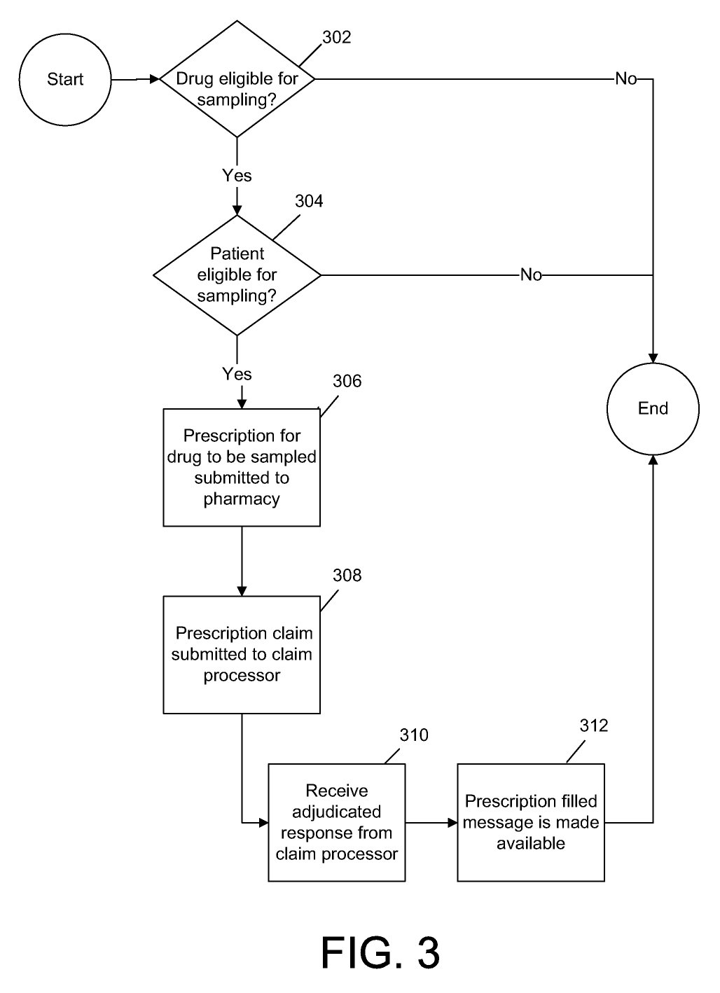

As described herein, the switch provider 104 may comprise computer-executable instruction for implementing one or more methods described herein, including processing, editing and/or routing prescription transactions pertaining to drugs to be sampled. The switch provider 104 may likewise be operative to store prescription data, patient data, and a listing of drugs available for sampling or for discounted co-pays, etc. in database(s) 142, which may include a distinct database and/or a database shared with the clinician systems 102, the pharmacy system 108, and/or the claim processor system 110. In an example embodiment of the invention, the database(s) 142 in communication with the switch provider 104 may include additional data to facilitate voucher data entry and processing including: patient rosters and/or patient pharmacy benefit cardholder IDs to facilitate patient eligibility request determinations (discussed with reference to FIG. 3 below), preferred pharmacy lists, a “Virtual Sample Formulary” data set inclusive of eligible drug information including the names of drugs eligible for sampling or discounted co-pays, etc. The database(s) 142 may also include details and restrictions on the use of the vouchers and coupons, as well as other data that may be useful in the processing of the voucher and/or coupon processing associated with the provided drug samples.

The pharmacy system 108 may include any processor-driven device that is configured for receiving, processing, and fulfilling prescription transactions for drug samples received from the clinician systems 102 via the switch provider 104. The pharmacy system 108 may include a processor 156, a memory 150, input/output (“I/O”) interface(s) 152, and a network interface 154. The memory 150 may store data files 146 and various program modules, such as an operating system (“OS”) 148, and the prescription claim module 144. The prescription module 144 may receive, process, and respond to prescriptions received from a clinician systems 102 via the switch provider 104 as well as generate claim transactions relating to the filled prescription to be routed to the claim processor system 110 via the switch provider 104.

The claim processor system 110 may include any processor-driven device that is configured for receiving, processing, and fulfilling requests relating to claim adjudication processing. According to an example embodiment of the invention, the claim processor system 110 may process prescriptions claims received from pharmacy systems 108 and/or clinician systems 102 via the switch provider 104. The claim processor system 110 may include a processor 158, a memory 160, input/output (“I/O”) interface(s) 162, and a network interface 164. The memory 160 may store data files 166 and various program modules, such as an operating system (“OS”) 168, a database management system (“DBMS”) 170, and an adjudication module 172. The adjudication module 172 may receive, process, and respond to claims received from the switch provider 104.

In FIG. 1, a clinician system 102, switch provider 104, pharmacy system 108 and claim processor system 110 may be in communication with each other via one or more networks 106. The one or more networks 106 may include any telecommunication and/or data network, whether public, private, or a combination thereof, including a public switched telephone network (PSTN), a cellular network, a local area network, a wide area network, an intranet, an internet, the Internet, intermediate hand-held data transfer devices, and/or any combination thereof and may be wired and/or wireless. The one or more networks 106 may also allow for real-time, off-line, and/or batch transactions to be transmitted between or among the clinician system 102, the switch provider 104, the pharmacy system 108, and the claim processor system 110. Due to network connectivity, various methodologies as described herein may be practiced in the context of distributed computing environments.

Those of ordinary skill in the art will appreciate that the system 100 shown in and described with respect to FIG. 1 is provided by way of example only. Numerous other operating environments, system architectures, and device configurations are possible. Accordingly, embodiments of the invention should not be construed as being limited to any particular operating environment, system architecture, or device configuration.

FIG. 2 shows a data flow between the entities of the prescription drug sampling system 200 for electronically submitted prescription transactions in accordance with an example embodiment of the invention. As shown in FIG. 2, once the patient and drug have been determined to be eligible for drug sampling processing (described below with reference to FIG. 3), a prescription transaction for a drug to be sampled is generated at the clinician's office 102 and sent to the PPE module 140 of the switch provider 104 as script 202. In the example embodiment of FIG. 2 the PPE module 140 and claim processing module 158 are incorporated into the switch provider 104. In alternative embodiments of the invention, the PPE module 140 and claim processing module 158 may be separate and distinct from the switch provider 104 and in communication with the switch provider 104. The PPE module 140 may pass the prescription transaction (script 203) directly to the pharmacy system 108 specified in the prescription transaction, or the PPE module 140 may review, process and/or amend the prescription to include the information necessary to provide the voucher (or coupon) for the drug to be sampled, or determine the pharmacy system 108 that should receive the prescription transaction (script 203). In an example embodiment of the invention, the PPE module 140 may be in communication with the claim processing module 158 to obtain information for use in the processing of the prescription transaction. In one example embodiment of the invention, the PPE module 140 and the claim processing module 158 may be in communication with each other either electronically, or in an alternative embodiment, data may be provided between the two modules manually.

Once the pharmacy receives script 203 from the PPE module 140, the pharmacy system 108 creates a claim (claim 204) corresponding to the prescription for the sampled drug to be adjudicated by the claim processor system 110 associated with the voucher (or coupon). The prescription claim (claim 204) is sent from the pharmacy to the claim processing module 158 of the switch provider 104 where the claim processing module 158 may simply route claim 204 to the corresponding claim processor system 110, or the claim processing module 158 may perform a variety of edits and review to ensure that claim 404 is in proper format for the corresponding claim processor system 110 as well as edit the claim to contain the appropriate information for proper adjudication of the voucher (or coupon) information. In an example embodiment of the invention, claim processing module 158 may be in communication with the PPE module 140 to obtain information relating to the drug sampling processing for use in the editing of the claim. In one example embodiment of the invention, the PPE module 140 and the claim processing module 158 may be in communication with each other either electronically, or in an alternative embodiment data may be provided between the two modules manually. Once the edits (if any) provided by the claim processing module 158 on claim 204 are completed, the claim (claim 205) is routed to the appropriate claim processing system 110.

The claim processing system 110 then adjudicates the claim and indicates the results of the adjudication in an adjudicated response message (adjudicated response 206) that is routed back to the pharmacy system 108 through the claim processing module 158. The claim processing module 158 may review adjudicated response 206 to update files pertaining to the transaction (e.g., patient eligibility files, transaction records, etc.). The update to the files may include sending information to the PPE module 140 for updating. The claim processing module 158 may also review and edit the adjudicated response 206 prior to forwarding the adjudicated response 206 to the pharmacy system 108 as adjudicated response 207.

Once the pharmacy system 108 receives the adjudicated response 207, the pharmacy may complete the filling of the prescription (if not already filled) and provides the drug samples to the patient (or the patient's representative). Once the drug samples have been provided to the patient by the pharmacy, the pharmacy system 108 then generates and transmits a confirmation message (confirmation 208) to be made available, via the PPE module 140, to the prescribing clinician's system 102. The PPE module 140 may review/edit the confirmation 208 and retain a record of the confirmation 208 received from the pharmacy system 108. When the clinician inquires as to the fulfillment of the prescription for the sampled drug, a report 209 identifying the prescription fulfillment status may be accessible by the physician via the web portal or otherwise. In an alternative embodiment of the invention, the report 209 may be transmitted to the clinician system 102 once the prescription has been filled without the clinician requesting the report 209.

In alternative embodiments of the invention, it is appreciated that one or more transmissions of a script, claim, adjudicated response, or confirmation may bypass the switch provider 104 (and/or the PPE module 140 or claim processing module 158) when communicating with the intended entity (e.g., clinician's office, pharmacy, or claim processor).

FIG. 3 shows a flowchart of the processing of prescription drug sampling transactions in accordance with an example embodiment of the invention. As shown in FIG. 3, the method for prescribing drug samples begins with step 302 where a determination is made as to whether the drug to be subscribed is eligible for sampling. In an example embodiment of the invention, the determination of drug eligibility may be made by the clinician's own knowledge of the available samples for that particular drug through education by the drug manufacturer representative or other means. In an alternative embodiment, the determination of drug eligibility may be made by a request for an indication of drug eligibility submitted by the clinician to the switch provider and/or drug manufacturer with a response being provided in or near real time. In another alternative embodiment, the clinician's system may be provided with or given access through a web portal to a listing of drugs that are eligible for sampling. In yet another alternative embodiment, a determination of drug sampling eligibility may be automatically conducted by the switch provider when an electronic prescription transaction has been submitted by the clinician system.

Next, a determination of patient eligibility for sampling is conducted at step 304. In an example embodiment of the invention, the patient's eligibility may be determined by the clinician submitting an eligibility request via accessing the web portal maintained at (or accessible through) the switch provider. The patient's eligibility is then determined and an indication of eligibility is sent in a response message to the prescribing clinician. In an example embodiment of the invention, the eligibility determination may be made by comparing the patient to a patient roster or accessing a patient eligibility file for eligibility information pertaining to the patient. In an example embodiment of the invention, a patient's eligibility may be determined based on a variety of factors including, the identity of the patient's healthcare provider or insurer, other medication the patient is taking, whether the patient has previously received samples for the same drug, demographic information associated with the patient (e.g., age, sex, address), etc. In an example embodiment of the invention, the response message sent to the prescribing clinician may specify the BIN (bank identification number), group number, and patient identification (e.g., card ID number) assigned to the patient to be included in the prescription for sampling the drug. In one embodiment of the invention a specific drug manufacturer supplied card ID number may be provided for that specific patient in an approved eligibility voucher/coupon response for use when processing the voucher/coupon to obtain the drug samples or to be used during adjudication of the claim for the drug samples.

Once eligibility to receive samples of the prescribed drug has been determined, step 306 is invoked where a prescription for the drug to be sampled is provided to a pharmacy. The prescription data to be included in the prescription transaction may include patient name, date of birth, gender, zip code (or address information), and/or the name of drug to be prescribed. The prescription data may also include a Pharmacy Benefit Cardholder ID, identification of a preferred pharmacy, the prescribed quantity, and dosing instructions. The prescription data may also include voucher/coupon information corresponding to the prescribed drug.

In an example embodiment of the invention, a patient is provided a voucher (or coupon) for the drug to be sampled. This physical voucher (or coupon) may be in the form of a letter that contains voucher (or coupon) redemption instructions. In an example embodiment of the invention, the voucher may be included with or incorporated into the physical prescription script provided to the patient. The voucher may specify the drug to be sampled as well as include patient identification information (e.g., Card ID number), BIN, group number, etc. The patient may then manually present the voucher (or prescription script containing the voucher) to a pharmacist at a pharmacy. In an alternative embodiment of the invention, the voucher (or prescription script containing the voucher) may be faxed from the clinician's office to a particular pharmacy.

In an alternative embodiment, the pharmacy may receive the prescription for the drug to be sampled electronically from the clinician's system to the pharmacy through the switch provider. In example embodiments of the invention, the transaction standard for the electronic prescription submission and/or other electronic transactions (e.g., patient or drug sampling eligibility inquiries, responses to the inquiries, prescriptions submissions, or the like, etc.) may be one of NCPDP SCRIPT, ANSI X12, HL7, or similar transaction standards. Alternatively, the electronic transactions and/or the format of the transactions may be proprietary. The electronic prescription submission may specify the drug to be sampled as well as include patient identification information, BIN, group number, voucher (or coupon) information, etc. In another embodiment of the invention, the prescription may be issued both electronically and manually to allow a variety of ways for the prescription and voucher information to be provided to the pharmacy and/or allow the patient to have a physical record of the transaction. In yet another alternative embodiment, a prescription may be provided from the clinician's system and the switch provider may provide the voucher information when routing the electronic prescription transaction to the pharmacy.

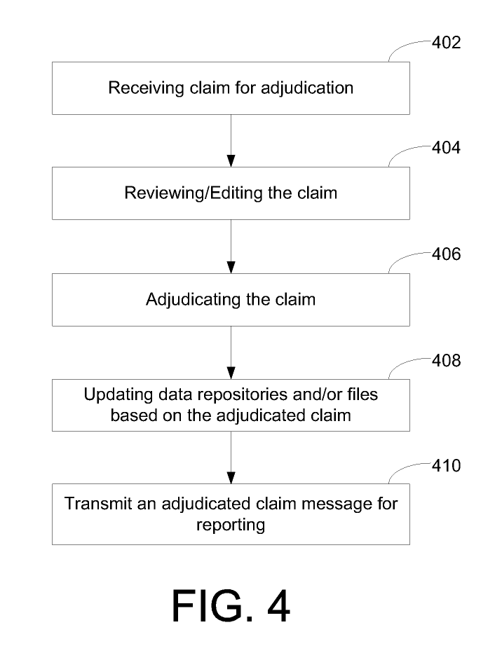

Once the pharmacy has received the prescription, step 308 is invoked where the pharmacy fills the prescription and creates a claim for the prescription filled to be submitted for adjudication to the corresponding claim processor (e.g., payer system) via the switch provider. Once the claim has been adjudicated, step 310 is invoked where an adjudicated message is sent to the pharmacy. The adjudication message may indicate the results of the claim processor system's adjudication of the claim associated with filling the prescription for the sampled drug. In an example embodiment of the invention, the submission of the claim may occur either before or simultaneously with filling the prescription for the drug to be sampled. The adjudication of the claim for the sampled drug is discussed in further detail below with reference to FIG. 4.

Finally, step 312 is invoked where a prescription filled message is made available to the clinician's system indicating that the drug samples have been provided to the patient. In an example embodiment of the invention, the clinician may access a report containing an indication of the prescription fulfillment status through the web portal. In an alternative embodiment of the invention, the clinician's office may periodically request confirmation that the patient (or the patient's representative) has been provided the drug samples by the pharmacy and the message indicating the status of the prescription fill for the drug to be sampled may be provided in response to those requests. In another alternative embodiment of the invention, the pharmacy (or switch provider) may directly transmit a message indicating prescription fulfillment to the clinician's office.

FIG. 4 shows a flowchart of the claim processor system adjudicating a claim for the drug sample prescription transaction in accordance with an example embodiment of the invention. As shown in FIG. 4, a claim submitted from a pharmacy is received in step 402. Step 404 is then invoked to review the claim to ensure the claim is in the appropriate form for adjudication by the claim processor. If the voucher information is present in or with the claim, then the claim is routed based on a BIN, group number, and/or patient identification information (e.g., card ID number) to the appropriate claim processor for adjudication. In an example embodiment of the invention, the BIN, group number and/or patient identification information may be altered as necessary to indicate to the claim processor that voucher information should be taken into account during the adjudication of the claim. If the claim includes, or is accompanied by, coupon information (e.g., patient to pay up to a certain amount), then the discount corresponding to the coupon information may be taken into account and/or indicated in the claim information routed to the claim processor for adjudication.

Next, the claim is adjudicated by the claim processor in step 406. During adjudication, the claim processor system may take into account the voucher and/or coupon information when charging or crediting the appropriate entity (e.g., the drug manufacture, patient's health insurance plan, pharmacy, or other entity offering the drug sample voucher or discount) for the transaction. Once the claim processor has adjudicated the claim, step 408 is invoked where claim repositories of the claim processor are updated. This update may include creating a record of the voucher or coupon use as well as provide a record or file of the prescribing clinician's and/or particular patient's use of the drug sample voucher or coupon. These records may be generated and maintained by the claim processor, switch provider, or both. The tracking of the use of the drug sample voucher and/or coupons allows for various types of statistical analyses to determine which clinician's are prescribing the drug samples, as well as analyses pertaining to the patients using those drug samples. For example, patient eligibility files may be maintained for tracking the patient's sampling of a particular drug to limit or prohibit further sampling of that drug by that patient and/or others associated with that patient (e.g., others included on that patient's health insurance plan, etc.). The switch provider and/or the claim processor system may maintain eligibility files using a combination of claim data and patient specific pharmacy data from participating pharmacy systems. Monitoring voucher or coupon use may also allows for follow up with a patient for feedback regarding the sampled drug. Data records pertaining to the adjudicated claims may also be reviewed by drug manufacturers, claim processors, and others in the industry for marketing purposes, as well as be useful by watchdog agencies to monitor abuse or misappropriation of the drug sample voucher/coupon usage. Finally, step 410 is invoked to transmit an adjudicated claim message back to the pharmacy via the switch provider. In an example embodiment of the invention, the adjudicated claim message may include the results of the adjudicated claim to be delivered to the switch provider and/or pharmacy.

Accordingly, many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of this application. Although specific terms are employed herein, they are used in a generic and descriptive sense only and not for purposes of limitation.

1. A method for processing drug sample prescription transactions comprising:
determining that a drug is eligible for sampling;
receiving a prescription transaction for the drug, wherein the prescription transaction specifies that the drug is eligible for sampling; and
submitting the prescription transaction for prescription fulfillment.

2. The method of claim 1, further comprising: prior to submitting a prescription transaction for the drug, determining that the patient is eligible for sampling of the drug.

3. The method of claim 1, wherein submitting the prescription transaction includes electronically routing the prescription transaction to a pharmacy over a network.

4. The method of claim 1, wherein submitting a prescription transaction for the drug to a pharmacy includes providing a patient with voucher information to be presented at the pharmacy.

5. The method of claim 1, further comprising:
providing a message to a clinician's office after the prescription transaction has been fulfilled.

6. The method of claim 1, wherein the prescription transaction for the drug includes voucher information associated with the drug.

7. The method of claim 1, wherein the a prescription transaction for the drug includes coupon information associated with the drug.

8. The method of claim 1, further comprising:
prior to submitting the prescription transaction for prescription fulfillment, amending the prescription transaction to include voucher information associated with the drug.

9. A system for processing drug sample prescription transactions comprising:
a memory device; and
a processor in communication with the memory device, wherein the processor is configured to execute instructions to:
determine that a drug is eligible for sampling,
receive a prescription transaction for the drug, wherein the prescription transaction specifies that the drug is eligible for sampling, and
submit the prescription transaction to a pharmacy for prescription fulfillment.

10. The system of claim 9, wherein the processor is further configured to execute instructions to:
prior to submitting a prescription transaction for the drug, determine that the patient is eligible for sampling of the drug.

11. The system of claim 9, wherein the software instructions for submitting the prescription transaction include electronically routing the prescription transaction to a pharmacy over a network.

12. The system of claim 9, wherein the software instructions for submitting a prescription transaction for the drug to a pharmacy include providing a patient with voucher information to be presented at the pharmacy.

13. The system of claim 9, wherein the processor is further configured to execute instructions to:
provide a message to a clinician's office after the prescription transaction has been fulfilled.

14. The system of claim 9, wherein the prescription transaction for the drug includes voucher information associated with the drug.

15. The system of claim 9, wherein the prescription transaction for the drug includes coupon information associated with the drug.

16. The system of claim 9, wherein the processor is further configured to execute instructions to:
prior to submitting the prescription transaction for prescription fulfillment, amend the prescription transaction to include voucher information associated with the drug.

17. A method for processing a claim associated with a prescription transaction for drug sampling comprising:
receiving, from a pharmacy, a claim associated with fulfillment of a prescription transaction for a drug eligible for sampling;
transmitting the claim to a claim processor;
receiving an adjudicated claim response message from the claim processor; and
transmitting at least a portion of the adjudicated claim response message to the pharmacy.

18. The method of claim 15, further comprising:
updating a database containing patient information with an indication that the patient has received the drug eligible for sampling.

19. The method of claim 15, wherein transmitting the claim to a claim processor includes routing the claim based on voucher information associated with the drug eligible for sampling.

20. The method of claim 15, further comprising:
prior to transmitting the claim to a claim processor, applying a discount to the claim, wherein the discount is associated with coupon information associated with the drug eligible for sampling.
